(19) United States
(12) Patent Application Publication
(10) Pub. No.: US 2025/0358897 A1
(43) Pub. Date: Nov. 20, 2025

(54) METHOD AND APPARATUS FOR SHARING MULTICAST-BROADCAST SERVICES ANNOUNCEMENT AND DE-ANNOUNCEMENT IN A WIRELESS COMMUNICATION SYSTEM

(71) Applicant: Samsung Electronics Co., Ltd., Suwon-si (KR)

(72) Inventor: Vijay SANGAMESHWARA, Bangalore (IN)

(21) Appl. No.: 19/209,376

(22) Filed: May 15, 2025

(30) Foreign Application Priority Data
May 17, 2024 (IN) 202441039015
Apr. 28, 2025 (IN) 202441039015

(51) Int. Cl. H04W 76/40; H04L 65/1104

(52) U.S. Cl. CPC H04W 76/40; H04L 65/1104

(57) ABSTRACT

The disclosure relates to a 5G or 6G communication system for supporting a higher data transmission rate. Specifically, the disclosure related to a method for sharing an announcement and a de-announcement of a multicast-broadcast services (MBS) session. The method comprises receiving an MBS usage information extensible markup language (XML) document from a SEAL network resource management-server (SNRM-S) module, wherein the MBS usage information comprises MBS session announcement/de-announcement information associated with one or more MBS sessions. Thereafter the method comprises parsing the received MBS usage information to extract MBS session announcement/de-announcement information. Further, the method comprises transmitting the parsed MBS session announcement/de-announcement information to at least one vertical application layer (VAL) client module in the UE.

### CROSS-REFERENCE TO RELATED APPLICATIONS

This application is based on and claims priority under 35 U.S.C. § 119 to Indian Provisional Specification patent application No. 202441039015, filed on May 17, 2024, and Indian Complete Specification patent application No. 202441039015, filed Apr. 28, 2025, both filed in the Indian Intellectual Property Office, the disclosures of which are incorporated by reference herein in their entirety.

### BACKGROUND

### 1. Field

The present disclosure relates, in general, to a service enabler architecture layer (SEAL) network resource management service in a fifth generation (5G) network. Particularly, but not exclusively, the present disclosure relates to a procedure to share multicast-broadcast services (MBS) session announcement and de-announcement in SEAL network resource management.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to wireless communication systems and, more specifically, the present disclosure relates to a method and apparatus for sharing multicast-broadcast services announcement and de-announcement in a wireless communication system.

One or more shortcomings of the prior art may be overcome and additional advantages may be provided through the present disclosure. Additional features and advantages may be realized through the techniques of the present disclosure. Other embodiments and aspects of the disclosure are described in detail herein and are considered a part of the claimed disclosure.

In an embodiment, the present disclosure provides new high-level procedures using HTTP protocol to enable the service enabler architecture layer (SEAL) network resource management Server (SNRM-S) to announce/de-announce the multicast-broadcast services (MBS) session to SEAL network resource management client (SNRM-C), as and when the MBS session is created, update or deleted over 5G network.

In an embodiment, the present disclosure may disclose a new procedure to perform announcement of the MBS session from SNRM-S to SNRM-C, when the SNRM-S create/updates an MBS session successfully on 5 GC. Also, the present disclosure may disclose a procedure to perform de-announcement of the MBS session from SNRM-S to SNRM-C, when the SNRM-S deletes an MBS session successfully on 5 GC. In the present disclosure, a new SEAL MBS Usage information XML schema is disclosed. Based on the XML schema, the present disclosure discloses a method for SNRM-S to generate the MBS announcement/de-announcement messages and a method for SNRM-C to parse the MBS announcement/de-announcement messages.

In an embodiment of the present disclosure, a method for sharing an announcement of a multicast-broadcast services (MBS) session at a user equipment (UE) is disclosed. The method comprises receiving, by a service enabler architecture layer (SEAL) network resource management-client (SNRM-C) module of a UE, an MBS usage information extensible markup language (XML) document from a SEAL network resource management-server (SNRM-S) module, wherein the MBS usage information comprises MBS session announcement information associated with one or more MBS sessions. Thereafter, the method comprises parsing, by the SNRM-C module, the received MBS usage information to extract MBS session announcement information. Further, the method comprises transmitting, by the SNRM-C module, the parsed MBS session announcement information to at least one vertical application layer (VAL) client module in the UE.

In an embodiment of the present disclosure, a method for sharing a de-announcement of a multicast-broadcast services (MBS) session at a user equipment (UE) is disclosed. The method comprises receiving, at a service enabler architecture layer (SEAL) network resource management-client (SNRM-C) module of the UE, an MBS usage information extensible markup language (XML) document from a SEAL network resource management-server (SNRM-S), wherein the MBS usage information comprises MBS session de-announcement information with one or more MBS sessions. Thereafter the method comprises parsing, by the SNRM-C module, the received MBS usage information to extract the MBS session de-announcement information. Further, the method comprises transmitting, by the SNRM-C module, the parsed MBS session de-announcement information to at least one vertical application layer (VAL) client module in the UE.

In an embodiment of the present disclosure, an apparatus for sharing an announcement of a multicast-broadcast services (MBS) session is disclosed. The apparatus comprises a processor and a memory is communicatively coupled to the processor. The memory stores the processor-executable instructions, which, on execution, causes the processor to receive an MBS usage information extensible markup language (XML) document from a service enabler architecture layer (SEAL) network resource management-server (SNRM-S) module, wherein the MBS usage information comprises MBS session announcement information associated with one or more MBS sessions. Thereafter the processor parses the received MBS usage information XML document to extract MBS session announcement information. Further, the processor transmits the parsed MBS session announcement information to at least one Vertical application layer (VAL) client module in a user equipment (UE).

In an embodiment of the present disclosure, an apparatus for sharing a de-announcement of a multicast-broadcast services (MBS) session is disclosed. The apparatus includes a processor and a memory is communicatively coupled to the processor. The memory stores the processor-executable instructions, which, on execution, causes the processor to receive an MBS usage information extensible markup language (XML) document from a service enabler architecture layer (SEAL) network resource management-server (SNRM-S), wherein the MBS usage information comprises MBS session de-announcement information with one or more MBS sessions. Thereafter the processor parses the received MBS usage information XML document to extract the MBS session de-announcement information. Further, the processor transmits the parsed MBS session de-announcement information to at least one vertical application layer (VAL) client module in a user equipment (UE).

The foregoing summary is illustrative only and is not intended to be in any way limiting. In addition to the illustrative aspects, embodiments, and features described above, further aspects, embodiments, and features will become apparent by reference to the drawings and the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The novel features and characteristics of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 illustrates an exemplary environment for sharing an announcement and a de-announcement of a MBS session in accordance with some embodiments of the present disclosure;

FIG. 2 illustrates a UE for sharing an announcement and a de-announcement of an MBS session in accordance with some embodiments of the present disclosure;

FIG. 3 illustrates a flowchart of a method for sharing an announcement of an MBS session at a UE in accordance with some embodiments of the present disclosure;

FIG. 4 illustrates a flowchart of a method for sharing a de-announcement of a MBS session at a UE, in accordance with some embodiments of the present disclosure;

FIG. 5 illustrates a sequence diagram of MBS session announcement from SEAL SNRM-S) to SEAL SNRM-C in accordance with some embodiments of the present disclosure;

FIG. 6 illustrates a sequence diagram of MBS session de-announcement from SEAL SNRM-S to SEAL SNRM-C in accordance with some embodiments of the present disclosure;

FIG. 7 illustrates an exemplary computer system according to embodiments of the present disclosure;

FIG. 8 illustrates a terminal (UE) according to embodiments of the present disclosure; and

FIG. 9 illustrates a network entity according to embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

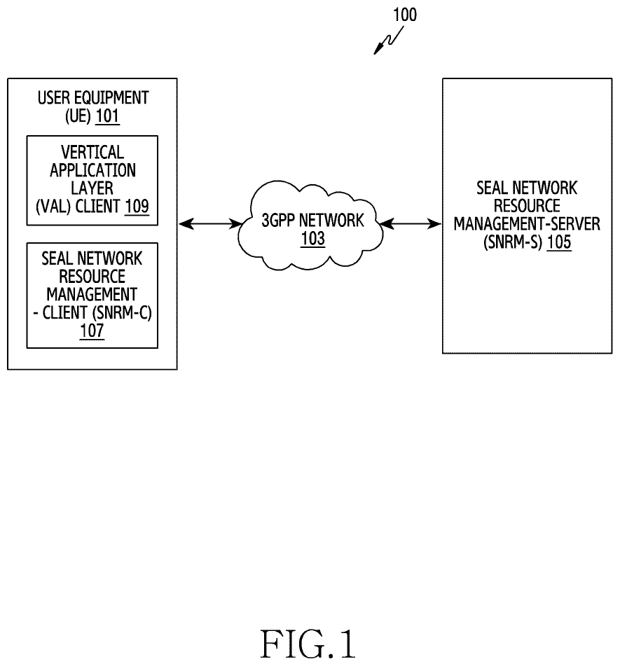

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises,” “comprising,” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the system or apparatus or method.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

In general, a 5G communication system is configured to provide advanced wireless communication capabilities, incorporating features and functionalities designed to meet the demands of next-generation communication networks. The system operates within various frequency bands, including but not limited to, sub-6 GHz bands and millimeter-wave (mmWave) frequency bands, such as the 28 GHZ, 39 GHz, and 60 GHz frequency ranges. SEAL was introduced as a framework within the 5G network standard. Also, SEAL was introduced in Release 16 to support easier and faster development and deployment of vertical applications (vertical app). There is a need for vertical app standards for different types of industries that are continuously increasing and many auxiliary services, such as location management, are needed across multiple vertical apps. Thus, capturing these commonly used auxiliary services and offering them to verticals as a common service layer, will benefit both verticals, allowing them to focus only on the core features and functionality of the vertical app, and operators, saving them from enormous efforts and time to develop the corresponding services for each vertical. The above concept became a reality with the standardization of SEAL architecture.

As of date third generation partnership project (3GPP) TS 24.548 specification for network resource management (NRM), does not define any procedures for the SEAL network resource management server (SNRM-S) to announce the 5G multicast broadcast services (MBS) session to SEAL network resource management client (SNRM-C) when the MBS session is created over 5G, for example, MBS session for a GROUP COMMUNICATION service. The group media (like audio, video, text, files and so on) may be shared over the MBS session through multi-cast/broadcast in the 5G network during the active group communication. However, when the MBS session is deleted over 5G, the de-announcement procedure is not defined in the technologies.

Thus, there is a need for a method and system which indicates addition, update and deletion of MBS sessions in the 5G network.

The information disclosed in this background of the disclosure section is only for enhancement of understanding of the general background of the disclosure and should not be taken as an acknowledgement or any form of suggestion that this information forms the prior art already known to a person skilled in the art.

The present disclosure related to a method and an apparatus for sharing an announcement and a de-announcement of a multicast-broadcast services (MBS) session. In an embodiment, service enabler architecture layer (SEAL) architecture supports two functional models: on-network (that is, SEAL-UU), when the UE connects to the 3GPP network system to consume the service, and off-network (that is, SEAL-PC5), when UEs connect to each other directly. The present disclosure focuses on a procedure that performs announcement and de-announcement of the MBS session from SNRM-S to SNRM-C, when the SNRM-S creates/updates or deletes an MBS session successfully on 5 GC. The MBS allows the network to select the most suitable among point-to-multipoint (PTM) or point-to-point (PTP) delivery based on requirements set by either service providers or network operators and/or considering concurrent user demand. The 5G MBS services rely on the establishment of MBS sessions to deliver data in downlink as a point-to-multipoint service from an application source to multiple end users. Further, the MBS sessions may consist of one or multiple MBS quality of service (QoS) flows addressing different service requirements.

In this manner, the present disclosure discloses a method and an apparatus for sharing an announcement and a de-announcement of a multicast-broadcast services (MBS) session with reference to FIGS. 1 to 7. In the figures, the same element or elements which have similar functions are indicated by the same reference signs.

In an embodiment, an exemplary environment 100 may include, without limiting to, a user equipment 101, and a SEAL network resource management-server (SNRM-S) 105 connected via a wireless network, such as 3GPP network 103. A SEAL network resource management-client (SNRM-C) 107 and a vertical application layer (VAL) client 109 may be included in the UE 101. The parts that are essential for the disclosure to work are only shown, and this should not be considered as a limitation. The SNRM-C 107 module communicated with the SNRM-S 105 over MBS sessions. The MBS sessions may be of two types: broadcast and multicast sessions. With broadcast MBS sessions, the data is simultaneously distributed over the radio interface to all users (UEs) located within a geographical area, that is, a configured broadcast coverage area. With multicast MBS sessions, the data is simultaneously distributed to a dedicated set of users (UEs) over the radio interface either by a PTP delivery method or a PTM delivery method. The SNRM-S 105 is connected to the 3GPP network 103 using a respective 3GPP interface specified by the 3GPP network system, for example through a SEAL-UU interface. The 3GPP network may be one of an Evolved Packed System (EPS) and a 5G System (5 GS). The SNRM-C 107 communicates with VAL client 109 over the SEAL-C interface. In some embodiment, the apparatus may be the the UE 101.

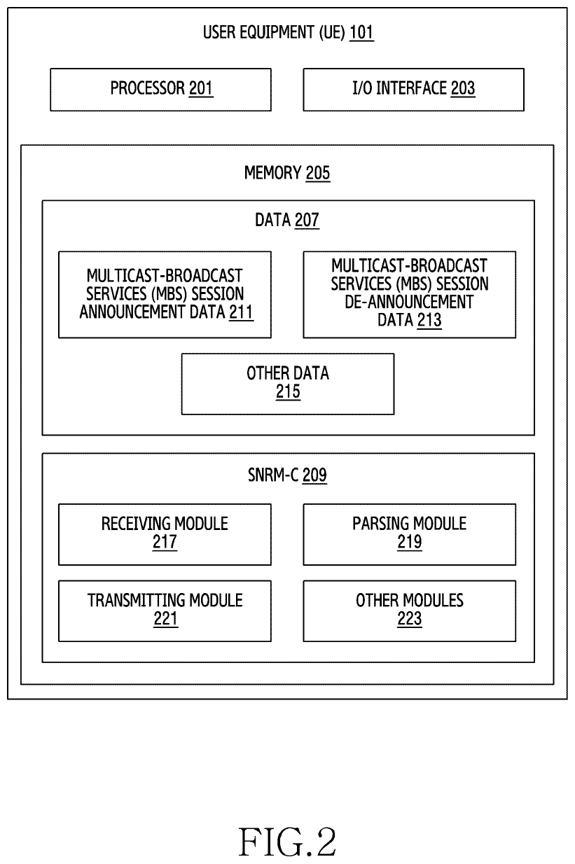

In an embodiment, the UE 101 comprises a processor 201 interfacing the memory 205 (shown in FIG. 2). The UE 101 may also include an Input/Output (I/O) interface 203 (shown in FIG. 2). As an example, a new high-level procedures using a hypertext transfer protocol (HTTP) POST request message to enable SNRM-S 105 to send MBS session announce message to SNRM-C 107, whenever the SNRM-S 105 creates and/or updates the MBS session successfully over the 3GPP network 103, that is, 5G network. Also, new high-level procedures using an HTTP POST request message to enable the SNRM-S 105 to send the MBS session de-announce message to the SNRM-C 107, whenever the SNRM-S 105 deletes the MBS session successfully over the 3GPP network 103, that is, 5G network.

### Generation of MBS Session Announcement Message in XML

In an embodiment, the generation of an MBS session announcement message in extensible markup language (XML) is disclosed. Initially, the SNRM-S 105 may generate the MBS session announcement XML message as per the schema defined in Table-1: which is represented by application/vnd.3gpp.seal-mbs-usage-info+xml MIME body with the <version> element set to “1” and one or more <mbs-announcement> elements associated with the pre-created MBS session.

Each set of an <mbs-announcement> element:
a) may include an <mbs-session-id> element set to the MBS session ID indicating the MBS session for the media stream currently being used.
b) may include an <mbs-session-props> element, containing the following sub-elements:
   1) <delivery-mode>, an element contains a string used to indicate whether to deliver the user data to the UE(s) via unicast mode or multicast mode:
      i) The value “broadcast” indicates to deliver the user data to the UE(s) 101 via broadcast mode.
      ii) The value “multicast” indicates to deliver the user data to the UE(s) 101 via multicast mode.
   2) <mbs-session-props> element, contains the following sub-elements which may include an <mbs-service-areas> element that provides one or more <mbs-service-area-id> sub-elements to provide applicable service areas of the MBS session.
c) Each set of an <mbs-announcement> element may include the below elements if SNRM-S requires such a report or a notification:
   1) <mbs-listening-status-notify> element set to “true” to indicate the SNRM-C to send listening status notification for this MBS session;
   2) <mbs-announcement-acknowledgement> element set to “true” to indicate the SNRM-C to send the MBS announcement acknowledgement on receiving this announcement; and
   3) <mbs-session-join-notify> element set to “true” to indicate the SNRM-C to send session join notification for when the VAL user or UE joins the group;
d) Each set of an <mbs-announcement> element may include a <seal-mbs-sdp> element set to the SDP with media and application control information applicable to groups that can use this MBS session; and
e) Each set of an <mbs-announcement> element may include a <mbms-announcement> element set to the announcement information as specified in clause 6.2.3.3.2.1.0 related to the established evolved multimedia broadcast multicast services (eMBMS) bearer, that shall be used by SNRM-C 107 when attached to the long term evolution (LTE).

TABLE 1
MBS Usage XML schema for MBS Session announcement message.

```
<?xml version=“1.0” encoding=“UTF-8”?>
<xs:schema xmlns:xs=“http://www.w3.org/2001/XMLSchema”
targetNamespace=“urn:3gpp:ns:sealMbsInfo:1.0”
xmlns:sealmbs=“urn:3gpp:ns:sealMbsInfo:1.0”
xmlns:sealmbms=“urn:3gpp:ns:sealMbmsInfo:1.0”
elementFormDefault=“qualified”
attributeFormDefault=“unqualified”
xmlns:xenc=“http://www.w3.org/2001/04/xmlenc#”>
  <!-- the root element -->
  <xs:element name=“seal-mbs-usage-info” type=“sealmbs:seal-mbs-usage-info-
Type” id=“mbs”/>
  <xs:complexType name=“seal-mbs-usage-info-Type”>
  <xs:sequence>
  <xs:element name=“mbs-announcement” type=“mbs-announcementTypeParams”
minOccurs=“0”/>
  <xs:element name=“version” type=“xs:integer”/>
  <xs:any namespace=“##other” processContents=“lax” minOccurs=“0”
maxOccurs=“unbounded”/>
  </xs:sequence>
  <xs:anyAttribute namespace=“##any” processContents=“lax”/>
  </xs:complexType>
  <xs:complexType name=“mbs-announcementTypeParams”
  <xs:sequence>
  <xs:element name=“mbs-session-id” type=“xs:string” minOccurs=“1”/>
  <xs:element name=“mbs-session-props” type=“mbs-session-propsType”
minOccurs=“1”/>
  <xs:element name=“mbs-listening-status-notify” minOccurs=“0”/>
  <xs:element name=“mbs-session-join-notify” minOccurs=“0”/>
  <xs:element name=“mbs-announcement-acknowledgement” minOccurs=“0”/>
  <xs:element name=“seal-mbs-sdp” type=“xs:string”/>
  <xs:element name=“announcement” type=“sealmbms:announcementTypeParams”
minOccurs=“0”/>
  <xs:any namespace=“##other” processContents=“lax” minOccurs=“0”
maxOccurs=“unbounded”/>
  </xs:sequence>
  <xs:anyAttribute namespace=“##any” processContents=“lax”/>
  </xs:complexType>
  <xs:complexType name=“mbs-session-propsType”>
  <xs:sequence>
  <xs:element name=“delivery-mode” type=“xs:string” minOccurs=“1”/>
  <xs:element name=“mbs-service-areas” type=“mbs-service-areas Type”
minOccurs=“0”/>
  <xs:any namespace=“##other” processContents=“lax” minOccurs=“0”
maxOccurs=“unbounded”/>
  </xs:sequence>
  <xs:anyAttribute namespace=“##any” processContents=“lax”/>
  </xs:complexType>
  <xs:complexType name=“mbs-service-areasType”>
  <xs:sequence>
    <xs:element name=“mbs-service-area-id” type=“xs:hexBinary”
    minOccurs=“1” maxOccurs=“unbounded”/>
  </xs:sequence>
  <xs:anyAttribute/>
  </xs:complexType>
  <xs:complexType name=“mbs-resource-requestType”>
  <xs:sequence>
  <xs:element name=“requester-identity” type=“xs:string” minOccurs=“0”/>
  <xs:element name=“VAL-group-id” type=“xs:string” minOccurs=“0”/>
  <xs:element name=“service-announcement-mode” type=“xs:string”
minOccurs=“0”/>
  <xs:element name=“QoS” type=“xs:string” minOccurs=“0”/>
  <xs:element name=“mbs-session-props” type=“mbs-session-propsType”
minOccurs=“0”/>
  <xs:any namespace=“##other” processContents=“lax” minOccurs=“0”
maxOccurs=“unbounded”/>
  </xs:sequence>
  </xs:complexType>
</xs:schema>
```

### Generation of MBS Session De-Announcement Message in XML:

In an embodiment, generating an MBS session de-announcement message in XML as per schema defined in Table-1 is disclosed. The SNRM-S 105 may create an MBS session de-announcement message which may be sent to SNRM-C 107. The SNRM-S 105 may generate an application/vnd.3gpp.seal-mbs-usage-info+xml MIME body with the <version> element set to “1” and one or more <mbs-announcement> elements. Each <mbs-announcement> element may include only the <mbs-session-id> element set to the MBS session ID that will be released.

In an embodiment, SNRM-S 105 HTTP procedures which may further include:
1. HTTP based MBS session announcement procedure; and
2. HTTP based MBS session de-announcement procedure.

### 1. HTTP Based MBS Session Announcement Procedure

Consider a scenario where the SNRM-S 105 shares the announcement of the MBS session to the SNRM-C 107 module in the UE 101. Initially, the VAL server requests the SNRM-S 105 to create a new MBS session or an update of an existing MBS session over the network for the particular bandwidth to deliver the user data. Once the MBS session with specified bandwidth is created, the SNRM-C 107 receives the MBS usage information via a hypertext transfer protocol (HTTP) POST request message from SNRM-S. The MBS usage information comprises MBS session announcement information associated with one or more MBS sessions. In order to share the MBS session announcement with the SNRM-C 107, the SNRM-S 105 may generate an HTTP POST request message in accordance with IETF RFC 9110. In the HTTP POST request message, the SNRM-S 105 may:
a) set the request-URI to the URI corresponding to the identity of the SNRM-C 107;
b) may include a content-type header field set to “application/vnd.3gpp.seal-mbs-usage-info+xml”;
c) include a MIME body in the HTTP POST request message, with the MIME content-type header field set to “application/vnd.3gpp.seal-mbs-usage-info+xml” and MIME payload with the MBS session announcement XML generated as specified in “generation of MBS session announcement message in XML”;
d) shall include a MIME body in the HTTP POST request message, with the MIME content-type header field set to “application/vnd.3gpp.seal-info+xml” and “and MIME payload with SEAL info XML as specified in clause 7.4.2 of 3GPP TS 24.548 where the <seal-request-uri> element:
1) include <VAL-user-id> element set to the VAL user ID of the user; and
2) include <VAL-group-id> element set to the VAL group identity that is served by this MBS session;
e) shall send the HTTP POST request towards SNRM-C 107 according to IETF RFC 9110 [22].

In an embodiment, the MBS session announcement procedure may be used by the SNRM-S 105 for announcement of both the pre-defined and on demand MBS session to the SNRM-C 107. The MBS session announcement procedure may be reused by SNRM-S 105 to share the associated information between a specific group communication and MBS session to the SNRM-C 107 to address the MapGroupToSessionStream procedure as specified in clause 14.3.4A.6.1 of 3GPP TS 24.434 [2].

In an embodiment, after receiving the MBS usage information, the SNRM-C 107 module transmits an acknowledgment of the received MBS usage information to the SNRM-S 105 module in response to the HTTP POST request message. Thereafter the SNRM-C 107 module parses the received MBS usage information to extract MBS session announcement information. Subsequently, the extracted information is notified by the SNRM-C 107 module to one or more vertical application layer (VAL) client 109 modules within the UE 101. The parsed MBS usage information may also be transmitted by the SNRM-C 107 module to at least one VAL client module within the UE 101. Further, based on the transmitted MBS usage information, the VAL client 109 module updates a group joining request to a service controller.

### 2. HTTP Based MBS Session De-Announcement Procedure

Consider another scenario where the SNRM-S 105 shares the de-announcement of the MBS session to the SNRM-C 107 module in the UE 101. Once the ongoing session usage is completed by the UE 101, the VAL server informs the SNRM-S 105 that the MBS session with specified allocated bandwidth is no longer required and may delete the created/updated session. Thereafter, the SNRM-C 107 module receives the MBS usage information via an HTTP POST request message from SNRM-S. The MBS usage information comprises MBS session de-announcement information associated with one or more MBS sessions. In order to share the MBS session de-announcement with the SNRM-C 107, the SNRM-S 105 may generate an HTTP POST request message in accordance with IETF RFC 9110 [22].
a) the SNRM-S 105 may set the Request-URI to the URI corresponding to the identity of the SNRM-C 107;
b) the SNRM-S 105 may include a Content-Type header field set to “application/vnd.3gpp.seal-mbs-usage-info+xml”;
c) the SNRM-S 105 include the mbs-usage-info XML payload in the HTTP POST body carrying the MBS session de-announcement XML generated below;
   1) an “application/vnd.3gpp.seal-mbs-usage-info+xml” with root element as <seal-mbs-usage-info>; and
      i) shall include <version> sub-element set to “1”; and
      ii) shall include one or more <mbs-announcement> elements, with each <mbs-announcement> element shall include only the <mbs-session-id> element set to the MBS session ID that will be released;
d) the SNRM-S 105 may send the HTTP POST request towards the SNRM-C 107 according to IETF RFC 9110 [22].

In an embodiment, after receiving the MBS usage information, the SNRM-C 107 module transmits an acknowledgment of the received MBS usage information to the SNRM-S 105 module in response to the HTTP POST request message. Thereafter the SNRM-C 107 module parses the received MBS usage information to extract MBS session de-announcement information. Subsequently, the extracted information is notified by the SNRM-C 107 module to one or more VAL client 109 modules. Further, the parsed MBS session de-announcement information is transmitted to at least one VAL client 109 module and terminates an active MBS session associated with the de-announced MBS session information.

In an embodiment, the present disclosure describes SNRM client HTTP procedures which includes MBS session announcement and de-announcement procedure as described below:
1. HTTP based MBS session announcement procedure
2. HTTP based MBS session de-announcement procedure

### 1. HTTP Based MBS Session Announcement Procedure

Upon receiving an HTTP POST request message from SNRM-S 105, the SNRM-C 107 may:
a) check if the Content-Type header field set to “application/vnd.3gpp.seal-mbs-usage-info+xml”;
b) check for the MIME body with the Content-Type header field set to “application/vnd.3gpp.seal-mbs-usage-info+xml” and process the MIME payload as per MBS session announcement XML as specified in clause “Generate MBS session announcement message in XML”. For each <mbs-announcement> element, the SNRM-C 107 shall check for:
   1) the <mbs-session-id> element to find the mbs-session-id;
   2) the <mbs-session-props> element to find the if the user data is delivered via broadcast or multicast mode;
   3) the <mbs-listening-status-notify> element set to “true” to indicate the SNRM-C 107 to send listening status notification for this MBS session;
   4) the <mbs-announcement-acknowledgement> element set to “true” to indicate the SNRM-C 107 to send the MBS announcement acknowledgement on receiving this announcement;
   5) the <mbs-session-join-notify> element set to “true” to indicate the SNRM-C 107 to send session join notification for when the VAL user or UE joins the group;
   6) the <seal-mbs-sdp> element to find if the SDP information associated with MBS session; and
   7) the <mbms-announcement> element to find if the established eMBMS bearer information that shall be used by the SNRM-C 107 when attached to the LTE.
c) the MIME body with the Content-Type header field set to “application/vnd.3gpp.seal-info+xml” and process the MIME payload as per SEAL info XML as specified in clause 7.4.2. For the <seal-request-uri> element:
   1) check for the <VAL-user-id> element to the find the VAL user ID of the user; and
   2) 2) check for the <VAL-group-id> element to the find VAL group identity that is served by this MBS session; and
d) send the HTTP response towards the SNRM-S according to IETF RFC 9110 [22].

### 2. HTTP Based MBS Session De-Announcement Procedure

Upon receiving an HTTP POST request message from SNRM-S 105, the SNRM-C 107 may:
a) check if the Content-Type header field set to “application/vnd.3gpp.seal-mbs-usage-info+xml”;
b) check for the MIME body with the Content-Type header field set to “application/vnd.3gpp.seal-mbs-usage-info+xml”;
c) process the MBS session de-announcement XML received in the HTTP POST request body, for each <mbs-announcement> element with an <mbs-session-id> sub-element the SNRM-C 107 checks if there exists an MBS session matching and notifies the associated VAL client; and
d) send the HTTP response towards the SNRM-S 105 according to IETF RFC 9110 [22].

FIG. 2 shows an internal block diagram of a user equipment (UE) for sharing an announcement/de-announcement of a multicast-broadcast services (MBS) session, in accordance with some embodiments of the present disclosure.

In an embodiment, the UE 101 may include data 207 and modules 209. As an example, the data 207 is stored in a memory 205 configured in the UE 101 as shown in the FIG. 2. In an embodiment, the data 207 may include an MBS session announcement data 211, an MBS session de-announcement data 213, and other data 215. In the illustrated FIG. 2, modules 209 are described herein in detail.

In an embodiment, the MBS session announcement data 211 comprises a plurality of elements configured to transmit MBS session announcement information to the UE 101. The plurality of elements includes, without limiting to, at least one of, an MBS session identifier, MBS session properties, an MBS listening status notify, an MBS announcement acknowledgment, an MBS session join notify, a SEAL MBS SDP information, and an MBMS announcement information. The MBS session identifier element is a unique identifier associated with the MBS session, which indicates the specific MBS session which is currently being available for a communication. The MBS session identifier element enables the identification and association of the MBS session with the corresponding multicast or broadcast media session, facilitating the proper handling of the MBS session within the UE 101. The MBS session properties element in the MBS session announcement comprises a delivery mode sub-element and an MBS service areas sub-element. The delivery mode sub-element indicates delivering the user data to the UE 101 in one of, a broadcast mode or a multicast mode. The MBS service areas sub-element provides information regarding the service areas applicable to the MBS session. The service areas define the geographical or logical regions within which the MBS session is applicable, thereby enabling the UE 101 to identify the specific areas covered by the session and deliver the user data. The MBS announcement acknowledgment element may be set to “true” to instruct the SNRM-C 107 module to transmit an acknowledgment upon receiving the MBS session announcement.

In an embodiment, the MBS session de-announcement data 213 includes details related to an existing MBS session. The MBS session de-announcement data 213 comprises a plurality of elements configured to transmit MBS session de-announcement information to the UE 101. The plurality of elements includes, without limiting to, an MBS session identifier and de-announcement information. The MBS session identifier element is a unique identifier associated with the active MBS session, which indicates the specific MBS session will be released and unavailable for communication.

In an embodiment, the data 207 may be stored in the memory 205 in the form of various data structures. The data 207 is continuously updated for subsequent analysis. Additionally, the data 207 may be organized using data models. The other data 215 may store data, including temporary data and temporary files, generated by the modules 209 for performing the various functions of the UE 101.

In some embodiments, the data 207 stored in the memory 205 may be processed by the modules 209 of the UE 101. The modules 209 may be stored within the memory 205. In an example, the modules 209 communicatively coupled to the processor 201 configured in the UE 101, may also be present outside the memory 205 as shown in FIG. 2 and implemented as hardware. The UE 101 further comprises an Input/Output (I/O) interface 203. The I/O interface 203 is coupled with the processor 201 through which an input signal or/and an output signal is communicated. The input signal and the output signal may represent data received by the UE 101 and data transmitted by the UE 101, respectively. In some embodiments, the UE 101 may be configured to receive and transmit data via the I/O interface 203. As used herein, the term modules refer to an application specific integrated circuit (ASIC), an electronic circuit, a processor (shared, dedicated, or group) and memory which executes one or more software or firmware programs, a combinational logic circuit, and/or other suitable components that provide the described functionality.

In an embodiment, the modules 209 may include, for example, a receiving module 217, a parsing module 219, a transmitting module 221, and other modules 223. The other modules 223 may be used to perform various miscellaneous functionalities of the UE 101. It will be appreciated that such aforementioned modules 209 may be represented as a single module or a combination of different modules. In some embodiments, the modules 209 may be part of SNRM-C 107 and configured to execute the functions of SNRM-C 107.

In an embodiment, the receiving module 217 may be configured to receive an MBS usage information extensible markup language (XML) document via the HTTP POST request message from the SNRM-S 105 module. The MBS usage information received via the HTTP POST request message comprises MBS session announcement information and the MBS session de-announcement information associated with one or more MBS sessions. The MBS session announcement information may be used by the SNRM-S 105 module to announce both the pre-defined MBS session and the on-demand MBS session to the SNRM-C 107 module.

In an embodiment, the parsing module 219 may be configured to parse the received MBS usage information via the HTTP POST request message to extract MBS session announcement information and the MBS session de-announcement information.

In an embodiment, the transmitting module 221 may be configured to transmit the parsed MBS session announcement information to at least one VAL client 109 module in the UE 101. Further, the transmitting module 221 may be configured to transmit the parsed MBS session de-announcement information to at least one VAL client 109 module in the UE 101.

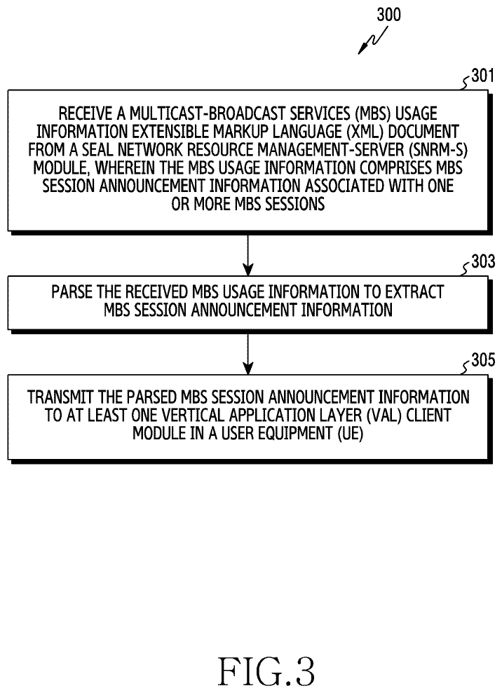

FIG. 3 shows a flowchart of a method for sharing an announcement of a multicast-broadcast services (MBS) session at a user equipment (UE), in accordance with some embodiments of the present disclosure.

As illustrated in FIG. 3, the method 300 includes one or more blocks illustrating a method for sharing the announcement of the MBS session. The method 300 may be described in the general context of computer executable instructions. Generally, computer executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the scope of the subject matter described herein. Furthermore, the method 300 can be implemented in any suitable hardware, software, firmware, or combination thereof.

At block 301, the method 300 may include, receiving, by a service enabler architecture layer (SEAL) network resource management-client (SNRM-C) module of a UE, an MBS usage information extensible markup language (XML) document from a SEAL network resource management-server (SNRM-S) module. The received MBS usage information comprises MBS session-specific announcement information associated with one or more MBS sessions. The MBS usage information is transmitted from the SNRM-S 105 module to the SNRM-C 107 module using a hypertext transfer protocol (HTTP) POST request message. The HTTP POST request used to transmit the MBS usage information comprises an MBS Usage Info XML in the request message. The MBS usage information includes essential session-related details, which are necessary for the UE to recognize and participate in the MBS session. Upon receiving the MBS usage information, the SNRM-C 107 module transmits an acknowledgment back to the SNRM-S 105 module in response to the HTTP POST request. The MBS session ID may indicate MBS session for the media stream currently being used. The MBS usage information may further include MBS session props that may include a string “broadcast” or “multicast” to indicating whether to deliver the user data to the UE 101 via the broadcast mode or the multicast mode. The MBS usage information may further include an <mbs-service-areas> element that provides one or more MBS service area id sub-elements to provide applicable service areas of the MBS session.

At block 303, the method 300 may include, parsing, by the SNRM-C 107 module, the received MBS usage information to extract MBS session announcement information. The parsing process involves extracting session-specific information from the MBS usage data, which may include the session identifier, session properties, delivery modes, and service areas. The parsed information is used to update the UE 101 regarding the available MBS sessions. After parsing the MBS usage information, the SNRM-C 107 module notifies at least one vertical application layer (VAL) client 109 module within the UE 101 of the extracted MBS session announcement information. For example, the SNRM-C 107 module may extract the MBS session ID from the <mbs-session-id> element. This ID indicates the ID of the MBS session for the media stream currently being used.

At block 305, the method 300 may include, transmitting, by the SNRM-C 107 module, the parsed MBS session announcement information to the at least one VAL client 109 module in the UE 101. After receiving the MBS session details, the at least one VAL client 109 module transmits the group join request to a service controller (such as the 5 GC network), enabling the UE 101 to join the specified MBS session group and participate in the MBS service.

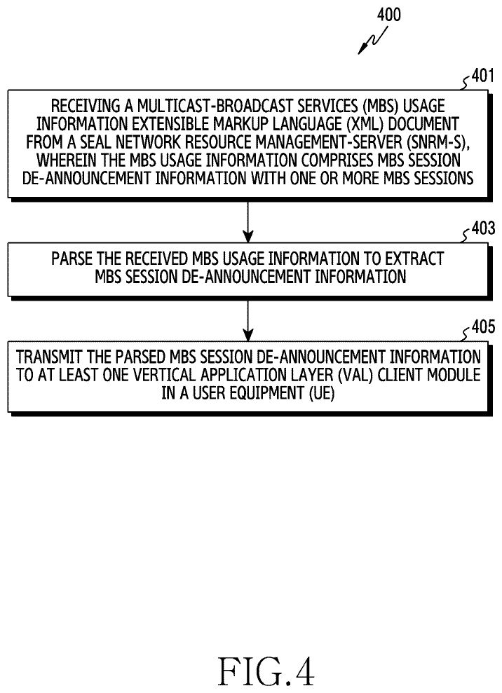

FIG. 4 shows a flowchart of a method for sharing a de-announcement of a multicast-broadcast services (MBS) session at a user equipment (UE), in accordance with some embodiments of the present disclosure.

As illustrated in FIG. 4, the method 400 includes one or more blocks illustrating a method for sharing the de-announcement of an MBS session. The method 400 may be described in the general context of computer executable instructions. Generally, computer executable instructions can include routines, programs, objects, components, data structures, procedures, modules, and functions, which perform functions or implement abstract data types.

The order in which the method 400 is described is not intended to be construed as a limitation, and any number of the described method blocks can be combined in any order to implement the method 400. Additionally, individual blocks may be deleted from the methods without departing from the scope of the subject matter described herein. Furthermore, the method 400 can be implemented in any suitable hardware, software, firmware, or combination thereof.

At block 401, the method 400 may include, receiving, at a SNRM-C 107 module of the UE 101, an MBS usage information extensible markup language (XML) document from a SNRM-S 105 module. The received MBS usage information comprises MBS session de-announcement information with one or more MBS sessions. The MBS usage information is transmitted from the SNRM-S 105 module to the SNRM-C 107 module using a hypertext transfer protocol (HTTP) POST request message. The HTTP POST request used to transmit the MBS usage information comprises an MBS usage Info XML-in the request message. Upon receiving the MBS usage information, the SNRM-C 107 module transmits an acknowledgment back to the SNRM-S 105 module in response to the HTTP POST request.

At block 403, the method 400 may include, parsing, by the SNRM-C 107 module, the received MBS usage information to extract the MBS session de-announcement information. After parsing the MBS session de-announcement information, the SNRM-C 107 module notifies at least one vertical application layer (VAL) client 109 module in the UE 101 of the extracted de-announcement information.

At block 405, the method 400 may include, transmitting, by the SNRM-C 107 module, the parsed MBS session de-announcement information to the at least one VAL client 109 module in the UE 101. Based on the MBS session de-announcement information, the VAL client 109 module stops receiving media from the active MBS session.

In an embodiment, a single HTTP POST request is used for announcement and de-announcement procedure. The SNRM-C 107 module uses the relevant information in the MBS usage information comprises an MBS Usage Info XML-in the request message for announcement procedure and the de-announcement procedure. For instance, for de-announcement procedure, the MBS usage information may include only MBS session ID, while for the announcement procedure, the MBS usage information may include the MBS session ID, the MBS delivery mode, the MBS service area ID.

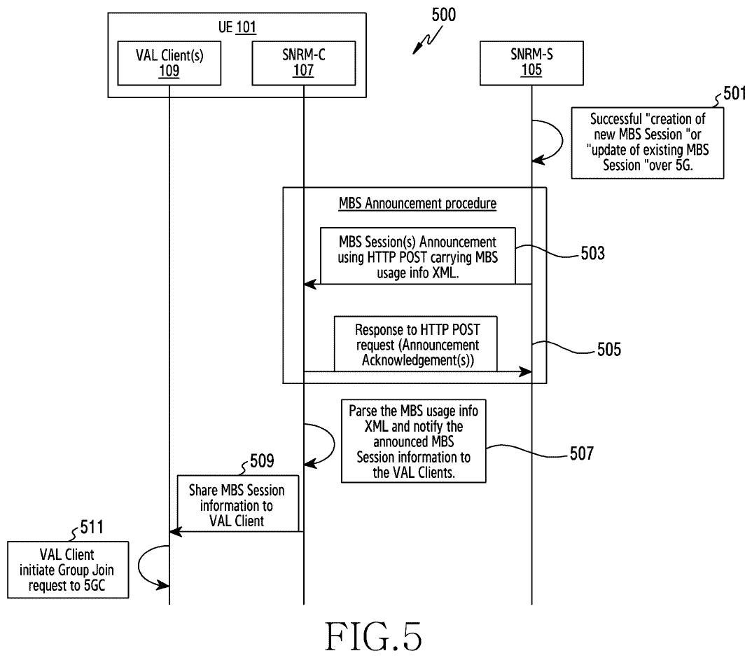

FIG. 5 illustrates a sequence diagram of multicast-broadcast services (MBS) session announcement from service enabler architecture layer (SEAL) network resource management-server (SNRM-S) 105 to SEAL network resource management-client (SNRM-C) 107, in accordance with some embodiments of the present disclosure. In an embodiment, at step 501, at the SNRM-S 105 side, there may be a creation of any new MBSs session or there may be an update of an existing MBS session in 5G which may perform to be reported to UE 101. Thus, the SNRM-S 105 may send MBS Session(s) Announcement using an HTTP POST message carrying MBS usage info XML as shown in step 503 of FIG. 5. Upon receiving the MBS session announcement message from SNRM-S 105, the SNRM-C 107 of the UE 101 may respond back to the SNRM-S 105 with an acknowledgment message (may be an HTTP POST response) as shown in step 505. Further, the SNRM-C 107 may parse the MBS Usage Info XML schema and notify the announced MBS session information to at least one VAL client 109 (step 507). The parsed information about the MBS session announcement may be shared with the at least one VAL client 109 as shown in step 509 of FIG. 5.

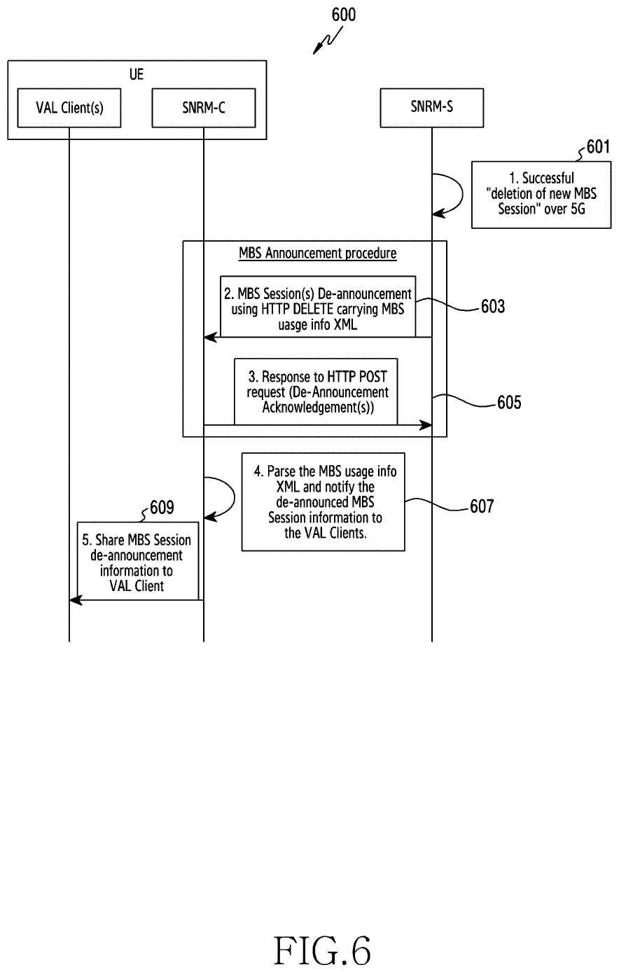

FIG. 6 illustrates a sequence diagram of multicast-broadcast services (MBS) session de-announcement from service enabler architecture layer (SEAL) network resource management-server (SNRM-S) 105 to SEAL network resource management-client (SNRM-C) 107, in accordance with some embodiments of the present disclosure. In an embodiment, at step 601, illustrates the successful deletion of existing MBS session. At step 603, if there is any deleted MBSs session determined, the same may be reported to UE 101. Thus, the SNRM-S 105 send MBS Session(s) de-announcement using HTTP POST message carrying MBS Usage Info XML schema as shown in step 603 of FIG. 6. Upon receiving the MBS session de-announcement message from SNRM-S 105, the SNRM-C 107 of the UE 101 may respond back to the SNRM-S 105 with a de-announcement acknowledgment message (may be an HTTP POST response) as shown in step 605. Further, the SNRM-C 107 parses the MBS Usage Info XML as shown in step 607 and notifies the de-announced MBS session information to the at least one VAL client as shown in step 609 of FIG. 6.

It may be noted here that the subject matter of some or all embodiments described with reference to FIGS. 1-6 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

### Computer System

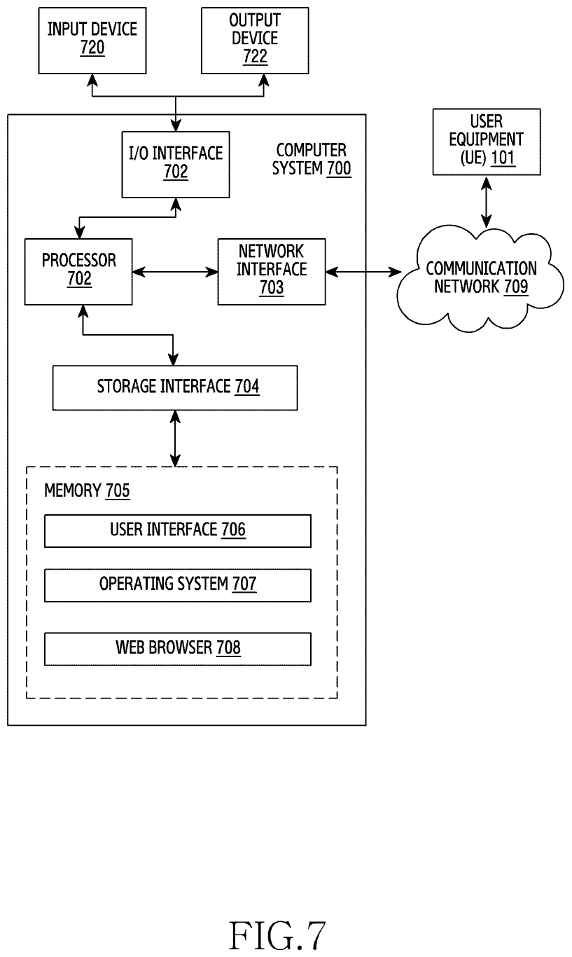

FIG. 7 illustrates an exemplary computer system according to embodiments of the present disclosure.

In an embodiment, FIG. 7 illustrates a block diagram of an exemplary computer system 700 for implementing embodiments consistent with the present disclosure. In an embodiment, the computer system 700 may be used for sharing an announcement and a de-announcement of a multicast-broadcast services (MBS) session. The computer system 700 may include a central processing unit (“CPU” or “processor”) 702. The processor 702 may include at least one data processor for executing program components for executing user or system-generated business processes. The processor 702 may include specialized processing units such as integrated system (bus) controllers, memory management control units, floating point units, graphics processing units, digital signal processing units, etc.

The processor 702 may be disposed in communication with one or more input/output (I/O) devices (710 and 711) via I/O interface 701. The I/O interface 701 may employ communication protocols/methods such as, without limitation, audio, analog, digital, stereo, IEEE-1394, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc. using the I/O interface 701, computer system 700 may communicate with one or more I/O devices (710 and 711).

In some embodiments, the processor 702 may be disposed in communication with a communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/Internet Protocol (TCP/IP), token ring, IEEE 802.11a/b/g/n/x, etc. using the network interface 703 and the communication network 709, the computer system 700 may communicate with a user equipment 101.

In some embodiments, the communication network 709 can be implemented as one of the different types of networks, such as an intranet or local area network (LAN) and such within the organization. The communication network 709 may either be a dedicated network or a shared network, which represents an association of the different types of networks that use a variety of protocols, for example, hypertext transfer protocol (HTTP), transmission control protocol/Internet Protocol (TCP/IP), wireless application protocol (WAP), etc., to communicate with each other. Further, the communication network 709 may include a variety of network devices, including routers, bridges, servers, computing devices, storage devices, etc. In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as serial advanced technology attachment (SATA), integrated drive electronics (IDE), IEEE-1394, universal serial bus (USB), fibre channel, small computer systems interface (SCSI), etc. The memory drives may further include a drum, magnetic disc drive, magneto-optical drive, optical drive, redundant array of independent discs (RAID), solid-state memory devices, solid-state drives, etc.

In some embodiments, the memory 705 may store a collection of program or database components, including, without limitation, a user interface 706, an operating system 707, a web browser 708 etc. In some embodiments, the computer system 700 may store user/application data, such as the data, variables, records, etc. as described in this disclosure. Such databases may be implemented as fault-tolerant, relational, scalable, secure databases such as Oracle or Sybase.

In some embodiments, the operating system 707 may facilitate resource management and operation of the computer system 700. Examples of operating systems include, without limitation, Apple Macintosh XTM, UNIX™, Unix-like system distributions (for example, Berkeley Software Distribution (BSD), FreeBSD, Net BSD™, Open BSD™, etc.), Linux distributions (for example, Red Hat, Ubuntu, K-Ubuntu, etc.), International Business Machines (IBM™) OS/2™, Microsoft Windows (XP™, Vista/7/8, etc.), Apple IOS, Google Android, BlackBerry operating system (OS), or the like. The User Interface 506 may facilitate display, execution, interaction, manipulation, or operation of program components through textual or graphical facilities. For example, user interfaces may provide computer interaction interface elements on a display system operatively connected to the computer system 700, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (for example, Aero, Metro, etc.), web interface libraries (for example, ActiveX®, Java®, JavaScript®, AJAX, HTML, Adobe® Flash®, etc.), or the like.

In some embodiments, the computer system 700 may implement the web browser 708 stored program components. The web browser 708 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), transport layer security (TLS), etc. Web browsers may utilize facilities such as AJAX, DHTML, Adobe Flash, JavaScript, Java, application programming interfaces (APIs), etc.

In some embodiments, the computer system 700 may implement a mail server stored program component. The mail server may be an Internet mail server such as Microsoft Exchange, or the like. The mail server may utilize facilities such as active server pages (ASP), ActiveX, american national standards institute (ANSI) C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like.

In some embodiments, the computer system 700 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, that is, non-transitory. Examples include random access memory (RAM), read-only memory (ROM), volatile memory, nonvolatile memory, hard drives, compact disc (CD) ROMs, digital video disc (DVDs), flash drives, disks, and any other known physical storage media.

In an embodiment, the present disclosure provides a method for sharing an announcement and a de-announcement of a Multicast-broadcast services (MBS) session in SEAL network resource management service in 5G network.

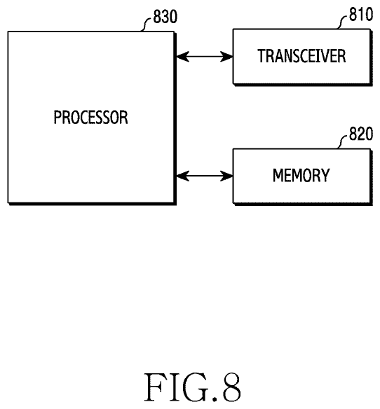

FIG. 8 illustrates a terminal (or a user equipment (UE)) according to embodiments of the present disclosure. FIG. 8 corresponds to the example of the UE of FIG. 4.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include an RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

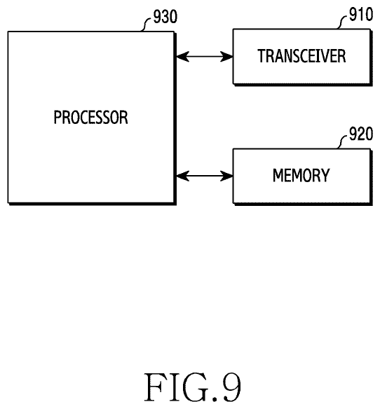

FIG. 9 illustrates a network entity according to embodiments of the present disclosure.

As shown in FIG. 9, the network entity according to an embodiment may include a transceiver 910, a memory 920, and a processor 930. The transceiver 910, the memory 920, and the processor 930 of the network entity may operate according to a communication method of the network entity described above. However, the components of the network entity are not limited thereto. For example, the network entity may include more or fewer components than those described above. In addition, the processor 930, the transceiver 910, and the memory 920 may be implemented as a single chip. Also, the processor 930 may include at least one processor.

The transceiver 910 collectively refers to a network entity receiver and a network entity transmitter, and may transmit/receive a signal to/from a terminal or other network entity. The signal transmitted or received to or from the terminal or other network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data for operations of the network entity. Also, the memory 920 may store control information or data included in a signal obtained by the network entity. The memory 920 may be a storage medium, such as read-only memory (ROM), random access memory (RAM), a hard disk, a CD-ROM, and a DVD, or a combination of storage media.

The processor 930 may control a series of processes such that the network entity operates as described above. For example, the transceiver 910 may receive a data signal including a control signal transmitted by the terminal, and the processor 930 may determine a result of receiving the control signal and the data signal transmitted by the terminal.

Certain aspects may comprise a computer program for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily perform realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a,′ “an” and “the” mean “one or more,” unless expressly specified otherwise.

The terms “an embodiment,” “embodiment,” “embodiments,” “the embodiment,” “the embodiments,” “one or more embodiments,” “some embodiments,” and “one embodiment” mean “one or more (but not all) embodiments of the disclosure” unless expressly specified otherwise.

The terms “including,” “comprising,” “having” and variations thereof mean “including but not limited to,” when used in a claim, is used in a non-exclusive sense that is not intended to exclude the presence of other elements or steps in a claimed structure or method, unless expressly specified otherwise.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure may not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a service enabler architecture layer (SEAL) network resource management (SNRM) client in a wireless communication system, the method comprising:
receiving, from an SNRM server, a hypertext transfer protocol (HTTP) POST request message;
identifying multicast-broadcast service (MBS) session announcement information for a first MBS session included in the HTTP POST request message; and
transmitting, to the SNRM server, a HTTP response message.

2. The method of claim 1, wherein the MBS session announcement information includes an MBS session identity (ID) for the first MBS session, an MBS session property, and a session description protocol (SDP) information for the first MBS session, and
wherein the MBS session property indicates a delivery mode for user data and service area ID for the first MBS session.

3. The method of claim 1, wherein MBS session de-announcement information for a second MBS session is identified in the HTTP POST request message,
wherein the MBS session de-announcement information includes an MBS session ID corresponding to the second MBS session to be released, and
wherein the second MBS session corresponding to the MBS session ID is notified to a vertical application layer (VAL) client.

4. The method of claim 3, wherein the MBS session announcement information and the MBS session de-announcement information are expressed using an extensible markup language (XML) format.

5. A service enabler architecture layer (SEAL) network resource management (SNRM) client of in a wireless communication system, the SNRM client comprising:
a transceiver; and
a controller coupled with the transceiver and configured to:
receive, from an SNRM server, a hypertext transfer protocol (HTTP) POST request message,
identify multicast-broadcast service (MBS) session announcement information for a first MBS session included in the HTTP POST request message, and
transmit, to the SNRM server, a HTTP response message.

6. The SNRM client of claim 5, wherein the MBS session announcement information includes an MBS session identity (ID) for the first MBS session, an MBS session property, and a session description protocol (SDP) information for the first MBS session, and
wherein the MBS session property indicates a delivery mode for user data and service area ID for the first MBS session.

7. The SNRM client of claim 5, wherein MBS session de-announcement information for a second MBS session is identified in the HTTP POST request message,
wherein the MBS session de-announcement information includes an MBS session ID corresponding to the second MBS session to be released, and
wherein the second MBS session corresponding to the MBS session ID is notified to a vertical application layer (VAL) client.

8. The SNRM client of claim 7, wherein the MBS session announcement information and the MBS session de-announcement information are expressed using an extensible markup language (XML) format.

9. A method performed by a service enabler architecture layer (SEAL) network resource management (SNRM) server in a wireless communication system, the method comprising:
setting a uniform resource identifier (URI) corresponding to an identity of an SNRM client;
generating a hypertext transfer protocol (HTTP) POST request message including the URI and multicast-broadcast service (MBS) session announcement information for a first MBS session;
transmitting, to the SNRM client, the HTTP POST request message; and
receiving, from the SNRM client, a HTTP response message.

10. The method of claim 9, wherein the MBS session announcement information includes an MBS session identity (ID) for the first MBS session, an MBS session property, and a session description protocol (SDP) information for the first MBS session, and
wherein the MBS session property indicates a delivery mode for user data and service area ID for the first MBS session.

11. The method of claim 9, wherein MBS session de-announcement information for a second MBS session is included in the HTTP POST request message, the MBS session de-announcement information includes an MBS session ID corresponding to the second MBS session to be released.

12. The method of claim 11, wherein the MBS session announcement information and the MBS session de-announcement information are expressed using an extensible markup language (XML) format.

13. A service enabler architecture layer (SEAL) network resource management (SNRM) server in a wireless communication system, the SNRM server comprising:
a transceiver; and
a controller coupled with the transceiver and configured to:
set a uniform resource identifier (URI) corresponding to an identity of an SNRM client,
generate a hypertext transfer protocol (HTTP) POST request message including the URI and multicast-broadcast service (MBS) session announcement information for a first MBS session,
transmit, to the SNRM client, the HTTP POST request message, and
receive, from the SNRM client, a HTTP response message.

14. The SNRM server of claim 13, wherein the MBS session announcement information includes an MBS session identity (ID) for the first MBS session, an MBS session property, and a session description protocol (SDP) information for the first MBS session, and
wherein the MBS session property indicates a delivery mode for user data and service area ID for the first MBS session.

15. The SNRM server of claim 13, wherein MBS session de-announcement information for a second MBS session is included in the HTTP POST request message, the MBS session de-announcement information includes an MBS session ID corresponding to the second MBS session to be released.

16. The SNRM server of claim 15, wherein the MBS session announcement information and the MBS session de-announcement information are expressed using an extensible markup language (XML) format.
